(19) United States
(12) Patent Application Publication
(10) Pub. No.: US 2013/0229892 A1
(43) Pub. Date: Sep. 5, 2013

(54) METHOD OF PREDICTING THE PRESSURE SENSITIVITY OF SEISMIC VELOCITY WITHIN RESERVOIR ROCKS

(71) Applicants: Norunn Skjei, Stavanger (NO); Per Åge Avseth, Stavanger (NO)

(72) Inventors: Norunn Skjei, Stavanger (NO); Per Åge Avseth, Stavanger (NO)

(73) Assignee: STATOIL ASA, Stavanger (NO)

(21) Appl. No.: 13/822,997

(22) PCT Filed: Sep. 13, 2011
(86) PCT No.: PCT/EP11/65887

§ 371 Date: May 8, 2013

Related U.S. Application Data
(60) Provisional application No. 61/382,780, filed on Sep. 14, 2010.

(51) Int. Cl. G01V 1/30

(52) U.S. Cl. CPC G01V 1/303
USPC 367/73

(57) ABSTRACT

A method of predicting the pressure sensitivity of seismic velocity within reservoir rocks includes defining the degree of cementation of rock as at least one of friable sand, partially cemented rock and cemented rock. For rock including friable sand, a first model specifying a dependence of seismic velocity upon pressure is defined. For rock including partially cemented rock, a second model specifying a dependence of seismic velocity upon pressure and a weighting function accounting for a degree of cementation of the rock is defined. For rock including cemented rock, a third model demonstrating an insensitivity of seismic velocity to pressure is defined. For a given dry rock moduli and porosity, the method includes determining a degree of cementation, selecting the appropriate model, and using the selected model to predict the sensitivity of seismic velocity to pressure.

### FIELD OF THE INVENTION

The present invention relates to a method of predicting the pressure sensitivity of seismic velocity within reservoir rocks. More generally, the invention relates to rock physics and the modeling of static and dynamic reservoir properties. The invention also relates to an heuristic approach for interpreting seismic activity within cemented sandstone reservoirs.

### BACKGROUND TO THE INVENTION

The general problem addressed by the present invention is how to predict the composition of a rock formation and, in particular, whether (and to what extent) it is saturated with oil, from seismic velocity measurements. In order to interpret seismic surveys it is necessary to establish relationships between the measured velocities and the intrinsic rock properties.

It is known that seismic compression (p) wave velocity is strongly dependent on an effective rock pressure. The effective pressure is the difference between the confining pressure (of the overlying rock column) and the pore pressure (which may be equal to, greater than or less than the hydrostatic pressure).

In general, velocity rises with increasing confining pressure and levels off (to a terminal velocity) when the effective pressure is high. This effect is thought to be due to crack closure: at low effective pressure cracks are open and easily closed by an increase in pressure (resulting in a small bulk modulus, K, and low velocity); as the effective pressure increases the cracks are all closed (resulting in an increase in K and in velocity).

Static rock physics modeling may be used to generate 3-Dimensional (3D) data plots of rock properties at a particular instance in time. Dynamic rock physics modeling, on the other hand, provides tools for estimating the evolution of rock properties over time. This is also referred to as 4-Dimensional (4D) modeling, where the fourth dimension represents time.

Rock physics models for fluid and stress dependency in reservoir rocks have been found to be essential for the quantification and interpretation of 4D seismic signatures during reservoir depletion and injection. However, our ability to predict the sensitivity of seismic data to pressure from first principles is poor.

The current state of the art requires that we calibrate the pressure dependence of seismic velocity with core measurements. A major challenge is the fact that consolidated rocks often break up during coring, and hence the pressure sensitivity is likely to be over-predicted in the laboratory relative to in-situ conditions. For unconsolidated sands, acquisition of core samples is not usually feasible due to the friable nature of the sediments.

One physical model that has been applied to predict pressure sensitivity in unconsolidated granular media is the Hertz-Mindlin contact theory (as described in, for example, Avseth et al., 2005, “Quantitative Seismic Interpretation; Applying Rock Physics Tools to Reduce Interpretation Risk”, Cambridge University Press). Several other empirical models have also been suggested (e.g. Bachrach and Avseth, 2008, “Rock physics modeling of unconsolidated sands: Accounting for non-uniform contacts and heterogeneous stress fields in the effective media approximation with applications to hydrocarbon exploration”, Geophysics, 73, E197-E209) which have fitting parameters that correlate with the micro-crack intensity, soft porosity and aspect ratio of the rock, and feasibility studies can be undertaken based on assumptions about these parameters. However, these models are not easily applied to moderately consolidated sandstones with contact cement, where crack parameters and aspect ratios are difficult to quantify.

In order to predict the seismic velocities of a rock at a given point in time, knowing only the porosity, mineralogic composition, and the elastic moduli of the mineral constituents, we can at best predict the upper and lower bounds of the seismic velocities. However, if we know the geometric details of how the mineral grains and pores are arranged relative to each other, we can predict more exact seismic properties using static rock physics modelling. There are several models that account for the microstructure and texture of rocks and these, in principle, allow us to go the other way: to predict the type of rock and microstructure from seismic velocities. This rock physics diagnostic technique was introduced by Dvorkin and Nur in 1996 as a means to infer rock microstructure from velocity-porosity relations. This technique is conducted by adjusting an effective-medium theoretical model curve to a trend in the seismic data, assuming that the microstructure of the rock matches that used in the model.

FIG. 1 illustrates three heuristic rock physics models that have been used to diagnose the rock texture of medium to high porosity sandstones comprising: a) the friable sand model; b) the contact cement model; and c) the constant cement model. These models are made by first defining the elastic properties of the “end members”. For example, at zero porosity, the rock must have the properties of mineral. At the high porosity limit, the elastic properties are determined by elastic contact theory. Interpolation between these two “end members” is then employed using, respectively, upper and lower Hashin-Shtrikman bounds. The upper bound explains the theoretical stiffest way to mix load-bearing grains and pore-filling material, while the lower bound explains the theoretical softest way to mix these materials. Hence, it has been observed that the upper bound is a good representation of contact cement, while the lower bound accurately describes the effect of sorting. However, it has been found that rocks with very little contact cement (of a few percent) are not well described by the Hashin-Shtrikman upper bound, because there is a large stiffening effect during the initial porosity reduction as cement fills in the microcracks between the contacts. In which case, it is not realistic to interpolate between the high-porosity and zero-porosity end member. It is therefore necessary to include a high-porosity contact cement model (i.e., the Dvorkin-Nur model) that takes into account the initial cementation effect. To date, these models have been used to quantify depositional sorting and diagenetic cement volume in reservoir sandstone intervals.

A main short-coming with the Dvorkin-Nur contact-cement model is that is does not include pressure sensitivity. Instead, it is assumed that the cemented grain contacts immediately loose pressure sensitivity as the cementation process initiates. However, from in-situ observations, we know that cemented reservoirs can have significant pressure sensitivity. This could either be related to fractures not captured by the microstructural scale model, or by a patchy cementation where some grain contacts are cemented and others are loose. FIG. 2 shows a section of sandstone reservoir rock comprising “patchy” cement. From this figure it can be seen that some of the grain contacts are clearly contact cemented 10, whereas others are loose and uncemented 12. It is believed that pressure sensitivity in such reservoirs will be due to the “loose” grain contacts 12.

As with the Hertz-Mindlin contact theory for loose granular media, the Dvorkin-Nur contact-cement model is also found to often overpredict shear stiffness in cemented sandstones. This could be related to non-uniform grain contacts and tangential slip at loose contacts, associated heterogeneous stress chains, and/or relative roll and torsion not taken into account in the contact theory. A reduced shear factor (Ft) has been introduced to honour this “reduced shear effect” in the contact theory and this varies between 0 and 1 representing the boundary conditions between no-friction (Walton smooth contact theory) and no-slip (Walton rough or Hertz-Mindlin contact theory) conditions, and for loose sands this parameter can be estimated directly from dry rock using Poisson's ratio. For cemented sandstones, this parameter is a pure fitting parameter, yet it has been found to correlate with the degree of cementation.

More details of the models discussed above (e.g. the Hertz-Mindlin contact theory model, the Walton smooth pressure sensitive model, the Hashin-Shtrikman model and the Dvorkin-Nur contact-cement model) are provided in “The Rock Physics Handbook: Tools for Seismic Analysis of Porous Media” by Gary Mavko, Tapan Mukerji and Jack Dvorkin.

### SUMMARY OF THE INVENTION

One way to heuristically quantify the pore stiffness of a rock is to measure the distance between an upper and a lower elastic bound at a given pressure. Marion and Nur introduced the Bounding Average Method as a relative measure of pore stiffness of a rock and this is illustrated in FIG. 3 which shows a graph of bulk modulus versus porosity. More specifically, the fractional vertical position A between the upper bound 14 and the lower bound 16 can be calculated as A=d/D, where D is the total vertical distance between the bounds at position A, d is the vertical position of A above the lower bound 16 and 0≦A≦1. Accordingly, for a given data point plotted on the graph of FIG. 3 (e.g. obtained from well-log data), we can calculate the relative pore stiffness of the rock.

A similar approach has been suggested to quantify the degree of consolidation, and to define a weight function, W, depending on where the rock data (e.g. sandstone data) is plotted between an upper and a lower bound in the elastic moduli versus porosity domain and this is illustrated in FIG. 4A for dry bulk modulus, K, and in FIG. 4B for dry shear modulus, G for an effective pressure of 20 MPa. In this example, the weight factor, W, is calculated from Equation (1) below, where K_{dry} is the pressure sensitive dry bulk modulus (which has been modeled or observed), K_{soft} is the pressure sensitive soft (i.e. lower bound) bulk modulus at the same porosity (P₀), and K_{stiff} is the pressure insensitive stiff (i.e. upper bound) bulk modulus at this porosity value.

$$W = \frac{{K}_{dry} ( {P}_{0} ) - {K}_{soft} ( {P}_{0} )}{{K}_{stiff} - {K}_{soft} ( {P}_{0} )} \qquad ( 1 )$$

A similar weight factor can also be calculated from the dry shear modulus data in FIG. 4B. FIGS. 4A and 4B therefore illustrate the degree of cementation and porosity required to give the respective dry bulk modulus and dry shear modulus results. However, these graphs do not illustrate whether and how these values depend upon pressure.

It is therefore an aim of the present invention to provide a method of predicting the pressure sensitivity of seismic velocity within reservoir rocks, which ameliorates at least some of the afore-mentioned problems.

It is proposed here to employ a method of predicting the pressure sensitivity of seismic velocity within reservoir rocks, and which comprises the following steps:
defining the degree of cementation of rock as at least one of friable sand, partially cemented rock comprising a degree of cementation up to a level at which the rock is substantially non-compressible, and cemented rock comprising a degree of cementation at which the rock is substantially non-compressible;
for rock comprising friable sand, defining a first model specifying a dependence of seismic velocity upon pressure;
for rock comprising partially cemented rock, defining a second model specifying a dependence of seismic velocity upon pressure and a weighting function accounting for a degree of cementation of the rock;
for rock comprising cemented rock defining a third model demonstrating an insensitivity of seismic velocity to pressure; and
for a given dry rock moduli and porosity, determining a degree of cementation, selecting the appropriate model, and using the selected model to predict the sensitivity of seismic velocity to pressure.

Thus, embodiments of the present invention provide a method which takes into account the level of cementation of the rock and which provides a suitable model for interpreting seismic velocity data (obtained from or modelled for a particular rock formation) and which includes pressure sensitivity in the model to an appropriate degree. An advantage of the present method is that the pressure sensitivity of partially cemented rock is accounted for.

It is noted that the terms ‘friable sand’, ‘loose sand’, ‘unconsolidated sand’ and ‘unconsolidated rock’ are used interchangeably throughout this specification. In addition, the terms ‘uncemented’, ‘partially cemented’ and ‘cemented’ have been used in a manner synonymous with the terms ‘unconsolidated’, ‘partially consolidated’ and ‘consolidated’, respectively.

The method of the present invention may be considered a ‘hybrid’ model as it combines existing models for unconcolidated and consolidated sands, respectively, into a model with can be used for partially consolidated sands.

The method is particularly suitable for use in relation to sandstone rock formations, although it may be applied to other rock types also.

The dry rock moduli and porosity may be obtained based upon well log data, i.e. data measured at specific well locations. Alternatively, the dry rock moduli and porosity may be obtained from a theoretical model of the rock geology.

Although data from core samples may be used to provide the dry rock moduli and porosity, it is an advantage of the present invention that the input data can be obtained without requiring such core samples.

In specific embodiments, well log data may be employed to calibrate one or more of the models.

The method may be used to quantify the sensitivity of seismic velocity within rock to pressure.

The method may be used to determine a pressure or pressure change within rock using seismic survey results.

The method may involve creating cross-plots of dry rock moduli versus porosity, including elastic bounds for different degrees of consolidation.

The effective rock moduli and corresponding seismic velocities as a function of pressure for a partially cemented rock may be estimated by a weighted average of the friable sand and cemented models.

The method may be used to quantify the sensitivity of seismic velocity to pressure in cemented sandstones, without the need for core measurements.

The method may be used during mapping of reservoir pressure from 3-D and 4-D seismic data.

The method may comprise the step of using the predicted pressure sensitivity to interpret seismic velocity data and thereby predict the composition of a rock formation.

All three models may be required in order to determine the degree of cementation, however, depending on the degree of cementation, one or more of the models may be required in order to determine the sensitivity of seismic velocity to pressure. Accordingly, if it is determined that the rock under consideration comprises only one of friable sand, partially cemented rock or cemented rock, the relevant model may be employed on the entire dataset. However, if it is determined that the rock under consideration comprises portions of more than one of friable sand, partially cemented rock or cemented rock, the relevant models may only be employed on the relevant portions of the dataset.

The first model for rock comprising friable sand may comprise or be based upon the Hertz-Mindlin model for unconsolidated sands. In certain embodiments, the first model may comprise the Walton Smooth contact theory model.

The second model for rock comprising partially cemented rock may comprise a modified contact model that is pressure sensitive. More specifically, the second model may comprise the Walton smooth pressure sensitive model or the Hertz-Mindlin model (defining a Hashin-Shtrikman soft bound) in combination with the Dvorkin-Nur contact cement model or the Constant Cement model (defining a Hashin-Shtrikman stiff bound).

The third model for rock comprising cemented rock may comprise or be based upon the Dvorkin-Nur contact cement model for consolidated sands or the Constant Cement model.

The degree of cementation may be determined by modelling upper and lower elastic bounds based on the porosity of the rock and then establishing the weighting function to account for the degree of cementation of the rock. Elastic bounds may be determined separately for bulk modulus and shear modulus data. Thus, different weighting functions (W_{K} and W_{G}) may be obtained in relation to the bulk modulus and the shear modulus data.

The lower (soft) bound may be determined using the Hertz-Mindlin model or the Walton Smooth model in combination with the Hashin-Shtrikman model to determine the relationship between the elastic moduli and porosity for unconsolidated sands at a given (in situ) pressure.

The upper (stiff) bound may be determined using the Dvorkin-Nur contact cement model or Constant Cement model in combination with the Hashin-Shtrikman model to determine the relationship between the elastic moduli and porosity for consolidated sands (i.e. where all grains are taken to be cemented). In practice, the upper bound is determined at the degree of cementation where the rock is substantially non-compressible and therefore the pressure sensitivity is determined to be negligible. Accordingly, the upper bound may be defined at a hypothetical maximum pressure where no further stress sensitivity will be seen.

In certain embodiments, the upper bound may be obtained by matching the Hertz-Mindlin model (or Walton smooth pressure sensitive model) with the lower bound Hashin-Shtrikman model at a very high pressure such that the upper bound superimposes onto a Constant Cement model (or Dvorkin-Nur contact cement model) for the cemented rock.

In particular embodiments, the degree of cementation at which the rock is considered substantially non-compressible and is therefore considered cemented rock may be 10%. In other embodiments, the degree of cementation at which no further stress sensitivity is observed may be 8%, 12% or another value obtained through further modelling and/or experimentation.

The Applicants envisage conducting further studies to determine uncertainties related to the upper and lower bounds and, if possible, to find ways to improve on the accuracy of the upper and lower bounds.

The weighting function may be linear and may vary between 0 representing no cementation and 1 representing the degree of cementation at which the rock is substantially non-compressible and therefore all grain contacts are taken to be cemented. The bulk modulus weighting function, W_{K}, may be calculated from Equation (2) below, where K_{dry} is the pressure sensitive dry bulk modulus (which has been modelled or observed) at porosity (P₀), K_{soft} is the pressure sensitive soft (i.e. lower bound) bulk modulus at the same porosity (P₀), and K_{stiff} is the pressure insensitive stiff (i.e. upper bound) bulk modulus at this porosity value.

$${W}_{K} = \frac{{K}_{dry} ( {P}_{0} ) - {K}_{soft} ( {P}_{0} )}{{K}_{stiff} - {K}_{soft} ( {P}_{0} )} \qquad ( 2 )$$

Similarly, the shear modulus weighting function, W_{G}, may be calculated from Equation (3) below, where G_{dry} is the pressure sensitive dry shear modulus (which has been modelled or observed) at porosity (P₀), G_{soft} is the pressure sensitive soft (i.e. lower bound) shear modulus at the same porosity (P₀), and G_{stiff} is the pressure insensitive stiff (i.e. upper bound) shear modulus at this porosity value.

$${W}_{G} = \frac{{G}_{dry} ( {P}_{0} ) - {G}_{soft} ( {P}_{0} )}{{G}_{stiff} - {G}_{soft} ( {P}_{0} )} \qquad ( 3 )$$

Thus, in the above embodiments, the linear weighting functions are used to interpolate between the soft and stiff bounds. In other embodiments, the weighting functions may be non-linear and may be obtained using other methods. For example, a two-step Hashin-Shtrikman modeling approach may be employed whereby a first interpolation is performed between uncemented and cemented end members at a high porosity, followed by a second interpolation between the high porosity and low porosity (mineral point) end members.

The weighting functions allow us to estimate vertical pressure sensitivity in partially cemented structures. The pressure dependence of the dry bulk and shear elastic moduli may be obtained using equations (4) and (5) below.

K_{dry}(P_{eff})=(1−W_{K})·K_{soft}(P_{eff})+W_{K}·K_{stiff} (4)

G_{dry}(P_{eff})=(1−W_{G})·G_{soft}(P_{eff})+W_{G}·G_{stiff} (5)

From these dry elastic moduli we may use known techniques to calculate the expected seismic velocities and acoustic impedances at various pressures (taking into account the effect of pore fluid using Gassmann's (1951) equations). For example, we may determine the stress sensitivity on these parameters for rock saturated with gas, oil or brine. We may then map well log data against the modelled data and correlate the results so as to establish the rock properties giving rise to the well log data. This therefore serves to indicate the likely rock structure producing the recorded seismic data. The method may also be used to determine how the properties of the rock have changed over time by comparing the results of seismic data obtained at one time to that obtained at another time.

The upper bound may be modelled first since it is both data and pressure independent. The lower bound may be modelled second as it is data independent but pressure dependent. An initial value for the pressure dependence may be input into the model for the lower bound from well log data or a geological model (e.g. where a cement volume is assumed). Well log data or modelled data may then be applied between bounds and the weighting functions and resulting pressure dependence calculated as described above before the data is converted into velocity plots for comparison with measured seismic data.

In some embodiments, regression modelling may be employed on a simulated dataset so as to derive equations for calculating seismic velocities directly from porosity, effective pressure and cement volume values.

In accordance with a second aspect of the invention, there is provided a computer system configured to carry out the above method.

In accordance with a third aspect of the invention, there is provided a computer program, comprising computer readable code which, when run on a computer system causes the computer system to carry out the above method.

In accordance with a fourth aspect of the invention, there is provided a computer program product comprising a computer readable medium and a computer program according to the third aspect of the invention, wherein the computer program is stored on the computer readable medium.

### BRIEF DESCRIPTION OF THE DRAWINGS

Embodiments of the invention will now be described with reference to the accompanying drawings, in which:

FIGS. 5A and 5B illustrate simulated data of respective bulk and shear moduli plotted at various effective pressures (0, 10 and 20 MPa), for varying porosity and cement volumes (as indicated by the scale);

FIG. 6 shows stress dependent curves for a range of porosities for sandstones saturated respectively with gas, oil and brine;

FIG. 7 shows dynamic rock physics modeling plotted alongside data for Gullfaks and Statfjord reservoir sands;

Note that the selected Gullfaks data plots along the more stress sensitive curves than the Statfjord data. This is likely related to the degree of consolidation.

FIGS. 8A and 8B show effective pressure versus dry p and s wave velocities at a porosity of 0.3 and a cement volume of 0.02 for both modeled data and that obtained using regression formulae;

FIGS. 9A, 9B and 9C show respectively how porosity, cement volume and effective pressure vary for saturated (upper trend data) and dry (lower trend data) Vp/Vs versus acoustic impedance, as generated from regression formulae.

### DETAILED DESCRIPTION OF CERTAIN EMBODIMENTS

An embodiment of the present invention there is provided a method of predicting the pressure sensitivity of seismic velocity within sandstone reservoir rocks, which comprises: defining the degree of cementation of rock as at least one of friable sand, partially cemented rock comprising a degree of cementation up to a level at which the rock is substantially non-compressible (in this example, up to 10% cementation), and cemented rock comprising a degree of cementation at which the rock is substantially non-compressible (in this example, 10% cementation and above). For rock comprising friable sand we define a first model specifying a dependence of seismic velocity upon pressure. For rock comprising partially cemented rock we define a second model specifying a dependence of seismic velocity upon pressure and a weighting function accounting for a degree of cementation of the rock. For rock comprising cemented rock we define a third model demonstrating an insensitivity of seismic velocity to pressure. For a given dry rock moduli and porosity, we determine a degree of cementation, select the appropriate model, and use the selected model to predict the sensitivity of seismic velocity to pressure.

In this embodiment, the first model employed for rock comprising friable sand is the Hertz-Mindlin contact theory model. The second model employed for rock comprising partially cemented rock comprises the Hertz-Mindlin contact theory model (defining a Hashin-Shtrikman soft bound) in combination with the Dvorkin-Nur contact cement model (defining a Hashin-Shtrikman stiff bound). The third model employed for rock comprising cemented rock is the Dvorkin-Nur contact cement model for consolidated sands.

The degree of cementation is determined by modelling upper and lower elastic bounds based on the porosity of the rock and then establishing the weighting function to account for the degree of cementation of the rock. The elastic bounds are determined separately for bulk modulus and shear modulus data such that different weighting functions (W_{K} and W_{G}) are obtained in relation to the bulk modulus and the shear modulus data. It should be noted that the weighting functions will be different for the bulk and shear moduli because the relative location of the elastic bounds will be affected by the reduced tangential shear stiffness mentioned above.

The lower (soft) bound is determined using the Hertz-Mindlin contact theory model in combination with the Hashin-Shtrikman model to determine the relationship between the elastic moduli and porosity for unconsolidated sands at a given (in situ) pressure.

The upper (stiff) bound is determined using the Dvorkin-Nur contact cement model in combination with the Hashin-Shtrikman model to determine the relationship between the elastic moduli and porosity for consolidated sands (i.e. having at least 10% cementation such that the effect of pressure is taken to be equivalent to that where all grains are cemented).

In this particular embodiment, the upper bound is estimated by matching the Hertz-Mindlin model with the lower bound Hashin-Shtrikman model at a very high pressure such that the upper bound superimposes onto a Constant Cement model for 10% cementation. This approach provides a soft and stiff bound with the same basic shape, which gives a more stable and realistic weighting function estimation for a given porosity value.

The weighting functions in the present embodiment are calculated in accordance with equations (2) and (3) above. The pressure sensitivity of the dry bulk and shear elastic moduli is then derived from the weighting functions in accordance with equations (4) and (5) above. Thus, by combining the Hertz-Mindlin contact theory model for unconsolidated sands with a stiff contact cement model, we can obtain a modified contact model for heterogeneous contacts that is pressure sensitive via the fraction of unconsolidated grain contacts.

Any sandstone data point (e.g. from well log data) can then be inverted for the weighting factors W_{K}, W_{G} allowing us to estimate stress curves for each data point.

In a particular example, the applicants simulated synthetic data for a wide range of porosities and cement volumes using the static rock physics models described above. The cement volume was varied between 0 and 10%, as it was assumed that if the cement volume was higher than this there will be no stress sensitivity at the grain contacts. Porosity was varied between 0 and 0.4 (i.e. 40%) and a synthetic elastic moduli dataset was created covering all possible combinations of porosity and cement volume within these ranges and the results are shown in FIGS. 4A and 4B. It should be noted that noise has been added to the results in order to make the dataset more realistic and to make the regression analysis described below more stable.

Next, the applicants estimated the soft and stiff bounds that enclose the simulated dataset in the moduli-porosity domain. These bounds were modeled by combining Hertz-Mindlin and lower bound Hashin-Shtrikman as described above. The soft bound is the unconsolidated sand model where the reference effective stress (P₀) is set to 20 MPa in this example. This represents the effective stress at around 2 km burial depth, which is the depth we expect quartz cementation to initiate in the North Sea. Any data point falling on this soft bound should represent unconsolidated sands where all grain contacts are stress-sensitive.

The stiff bound is defined by increasing the effective stress in the Hertz-Mindlin model so that it mimics the 10% constant cement model. In this example, we find that an effective stress of 600 MPa must be selected in order to get this match. For any practical reason, this stiff bound should therefore be considered what happens when all grain contacts are closed, and there is no stress sensitivity in the sandstone data falling on this bound. A linear weighting function is then defined between the soft and the stiff bounds (e.g. using Equations 2 and 3), both for bulk modulus and shear modulus versus porosity. This weighting function will define the stress sensitivity of the cemented sandstone. In this example, the soft bound is defined with a reduced shear factor Ft=0. The reduced shear factor for the stiff bound is set to 0.5. It has been demonstrated that this parameter is depth dependent and likely associated with degree of diagenesis. This parameter may therefore be further updated in an iterative scheme to fit a calibration data set (not demonstrated here).

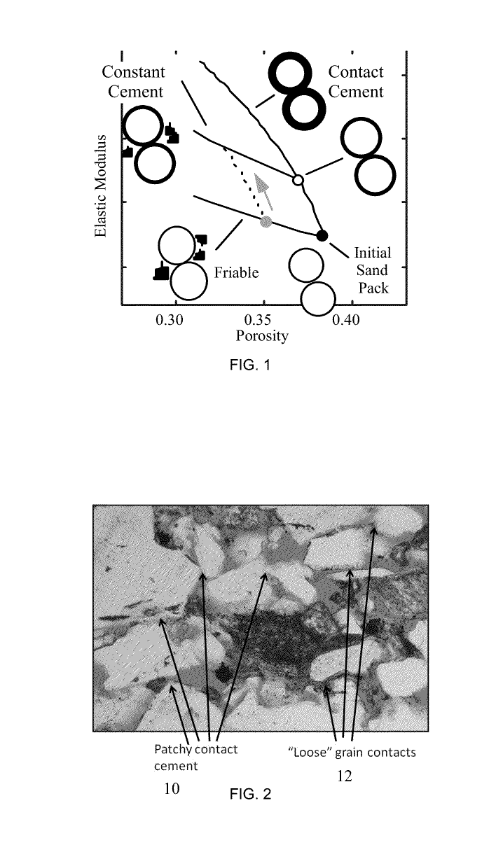

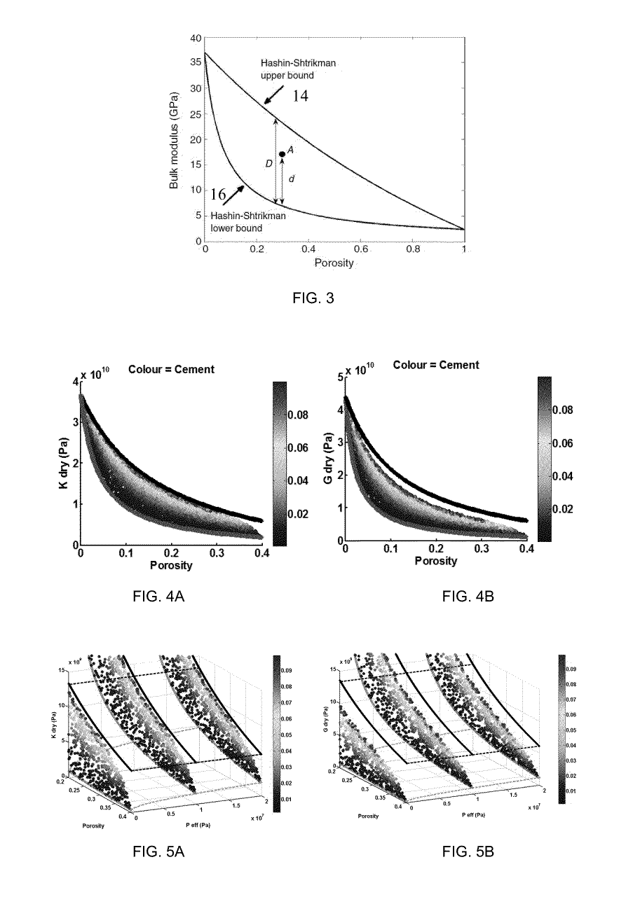

Next, we derive the effective bulk and shear modulus as a function of effective stress for the cemented sandstones, depending on the estimated weight factors (i.e. consolidation degree). FIGS. 5A and 5B show the simulated data of respective bulk and shear moduli plotted at various effective pressures (0, 10 and 20 MPa), for porosities ranging from 0.2-0.4 and cement volumes up to 10% (as indicated by the scale). The stress sensitive ‘Hertzian’ soft bound ‘plane’ and the stress insensitive (‘flat’) stiff bound ‘plane’ are indicated in dashed lines. The estimated weighting functions determine the stress sensitivity of the data plotting in-between these bounds. Note that the data plotting close to the soft bound shows significant pressure sensitivity whereas the well-cemented data plotting close to the stiff bound shows no or insignificant stress sensitivity.

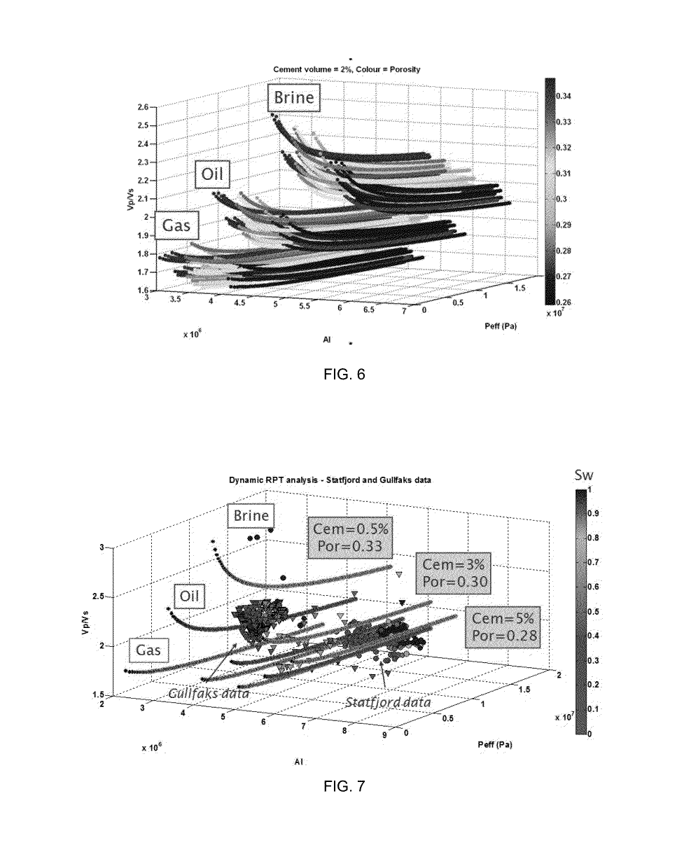

From these dry elastic moduli the applicants used known techniques to calculate the expected seismic velocities and acoustic impedances at various pressures (taking into account the effect of pore fluid using Gassmann's (1951) equations). Accordingly, FIG. 6 shows stress dependent curves in terms of Vp/Vs and acoustic impedances (Al) for a range of porosities (0.26-0.35) for sandstones saturated respectively with gas, oil and brine and where the cement volume is 2%. Note that the stress sensitivity is larger for brine than for oil, and that almost no stress sensitivity is observed for gas saturated sandstones.

We then map well log data against the modelled data and correlate the results so as to establish the rock properties giving rise to the well log data. FIG. 7 shows well log data from target zones in two selected wells from the Statfjord and Gullfaks fields, respectively. Note that the selected Gullfaks data plots close to the more stress sensitive curves than the Statfjord data. This is likely related to the degree of consolidation. In fact, the Gullfaks reservoir sands in this example are found to be unconsolidated with no or almost no cement whereas the Statfjord reservoir sandstones are found to be slightly cemented. We include in the graphs stress curves in the Vp/Vs versus Al domain for selected porosities and cement volumes, and for different pore fluid types (brine, oil, gas). The results show that when cement volume is approaching zero, the stress sensitivity is increasing drastically when the sands are saturated with oil or brine. The Gullfaks data is plotting close to the curves modeled for 0.5% cement and a porosity of 0.33. The Statfjord reservoir data is plotting between the models where we assume cement volume to be between 3-5%. Accordingly, we expect a much lower stress sensitivity in this instance during drainage or injection.

Simplified Regression Models and Dynamic Rock Physics Templates

In another embodiment, regression modelling is employed on a simulated dataset so as to derive equations for calculating seismic velocities directly from porosity, effective pressure and cement volume values.

In this particular example, a nonlinear regression is performed on the simulated dataset for porosities ranging from 0.20 to 0.40. Strictly speaking, contact theory is only valid at relatively high porosities (of greater than approximately 0.20) and pressure sensitivity at lower porosities should be quantified using inclusion models (i.e. aspect ratios). Moreover, the applicants have found that regression easily becomes unstable if we include the whole porosity range since the shape of the velocity-porosity trends are very different at lower porosities relative to higher porosities.

In this example, the applicants chose a mathematical formulation similar to the one suggested by Eberhart-Phillips et al. (1989). However, slight modifications were made to obtain a satisfactory fit between the regression formulae and the simulated data.

Firstly, regression was performed on the “plane” representing well-cemented sandstones, with cement volumes ranging from 0.08-0.1. The resulting dry velocities were found to be given by equations (6) and (7) below as a function of porosity and effective pressure:

Vp_{stiff}=4992−10171·φ+9548·φ²+123·P_{eff}^{0.2777} (6)

Vs_{stiff}=3013−5513·φ+3519·φ²+106·P_{eff}^{0.2851} (7)

Next, regression on the “plane” representing unconsolidated sands (i.e. no cement) was performed. The simulated data here represents sands with only Walton smooth contacts (i.e. Hertz-Mindlin with a reduced shear factor Ft=0). The resulting dry velocities were found to be given by equations (8) and (9) below as a function of porosity and effective pressure:

Vp_{soft}=1204−6069·φ+5788·φ²+exp(7.377)·P_{eff}^{0.1556} (8)

Vs_{soft}=769−3799·φ+3562·φ²+exp(6.839)·P_{eff}^{0.1582} (9)

Finally, we define the dry velocities as a function of porosity, effective pressure and cement volume to be a weighted average of the soft and the stiff velocities, with respect to cement volume in accordance with equation (10):

$${Vp}_{eff} = {[ \frac{( 0.09 - Cem )}{0.09} \cdot {Vp}_{soft}^{n ( {P}_{eff} )} + \frac{Cem}{0.09} \cdot {Vp}_{stiff}^{n ( {P}_{eff} )} ]}^{1 / n ( {P}_{eff} )} \qquad ( 10 )$$

where n(P_{eff})=3.5+2·P_{eff}/ 20e6, reflecting that the weighting average will change with pressure. The same formulation is then applied to determine effective shear wave velocities also.

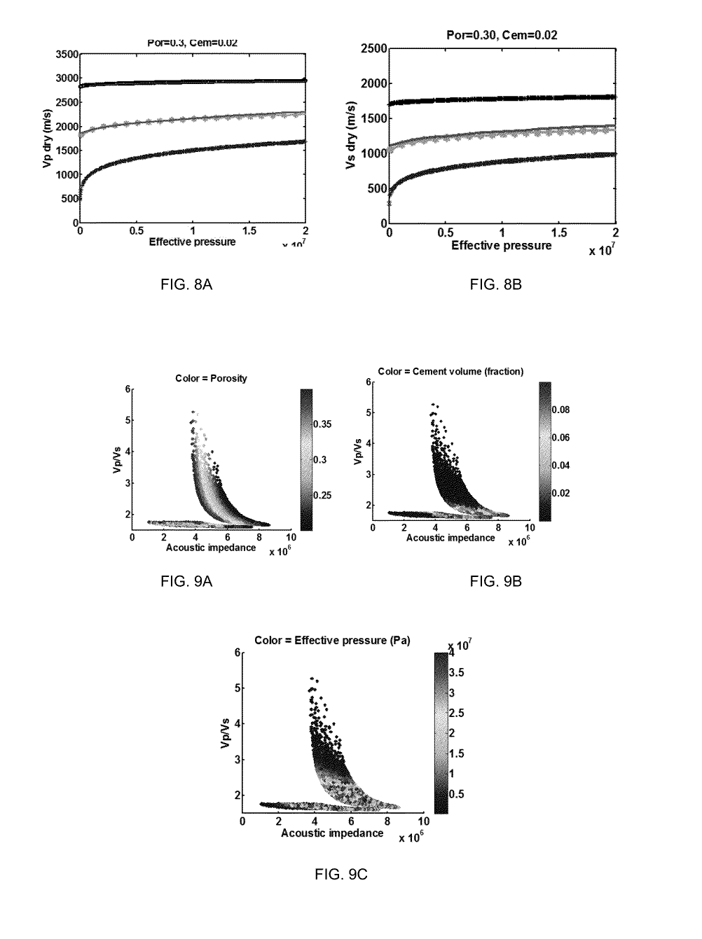

FIGS. 8A and 8B show effective pressure versus dry p and s wave velocities at a porosity of 0.3 and a cement volume of 0.02 for both modeled data and that obtained using the regression formulae above. The bottom line shows the soft bound at the given porosity and the top line shows the corresponding stiff bound. The points plotted in-between the bounds are the simulated data extrapolated from 20 MPa down to 0 MPa for the given combination of porosity and cement volume. The middle line represents the stress curve predicted by the regression model. As can be seen, there is an overall good match between the regression-modeled line and the simulated data. This shows that we can use the regression formulae directly to establish dynamic rock physics templates for different types of reservoirs (i.e. with varying porosity and cement volume).

FIGS. 9A, 9B and 9C show respectively how porosity, cement volume and effective pressure vary for saturated (upper trend data) and dry (lower trend data) Vp/Vs versus acoustic impedance plots as generated from regression formulae. In these examples, we have input all porosities between 0.2-0.4, all cement volumes between 0-0.1, and all effective pressures between 0-40 MPa. We note that saturated Vp/Vs ratios vary drastically at low cement volumes and low effective pressures. Acoustic impedance changes are, however, found to correlate strongly with porosity and cement volume for both dry and saturated scenarios. The regression formulae have also been tested on real data from the Gullfaks and Statfjord fields and the results are encouraging.

In accordance with the above, the applicants have established a heuristic approach to estimate fluid (using existing Gassman's theory) and pressure sensitivity in cemented sandstones using non-uniform contact theory combined with modified Hashin-Shtrikman elastic bounds. Embodiments of the invention expand on existing static models of cemented sandstones to account for stress sensitivity using elastic bounds in the porosity-moduli domain, where we define a soft bound to be stress sensitive (c.f., Hertz-Mindlin contact theory) and a stiff bound to be insensitive to stress (c.f., Dvorkin-Nur contact cement model). Based on the location of a data point (well log data or inverted seismic data) between these bounds, we are able to quantify expected pressure and fluid sensitivity in elastic and seismic properties (including moduli, velocities, acoustic impedance and Vp/Vs) of cemented sandstones. We have also established regression formulas that can be used to estimate dynamic rock physics templates for reservoir sandstones where the input parameters are confined to cement volume, porosity and effective pressure. This approach can be applied to predict the effect of pressure changes for example during 4-D monitoring analysis.

In the above embodiments, we assume that the cemented rock consists of a binary mixture of cemented and uncemented grain contacts, or “patchy cementation” (as shown in FIG. 2). Assuming that the cemented “stiff” grain contacts are stress-insensitive and the unconsolidated “loose” grain contacts are stress-sensitive according to Hertzian contact theory, the hybrid model of the present invention allows us to predict the pressure sensitivity in cemented sandstones.

A rough “fudge” parameter during application of contact theory is the so-called “slip-factor” or reduced shear factor. It is often seen that Hertz-Mindlin as well as Dvorkin-Nur overpredicts shear stiffness compared to measurements. In loose sands, it is shown that the Walton smooth contact theory (no friction) often gives the best fit. With increasing consolidation and/or pressure, the Hertz-Mindlin model gradually becomes more suited. Further studies will be conducted to better understand the physics behind the slip-factor and, if possible, obtain a better understanding of how this parameter varies as a function of, for example, burial depth and pressure.

Embodiments of the present method may assume clean, homogenous and isotropic reservoir sandstones. Presence of clay in the rock frame can be accounted for in the existing workflow. However, interbedded sand-shale sequences will affect pressure sensitivity in a more complex way. It is possible that depletion of reservoir sands will cause pore pressure increase in interbedded shales. Very little work has been done to model or document the effect of heterogeneity on pressure sensitivity and the plan is to investigate this in more detail.

It will be understood that various modifications may be made to the above described embodiments without departing from the scope of the present invention, as defined in the accompanying claims.

1-36. (canceled)

37. A method of predicting the pressure sensitivity of seismic velocity within reservoir rocks, and which comprises the following steps:
defining the degree of cementation of rock as at least one of friable sand, partially cemented rock comprising a degree of cementation up to a level at which the rock is substantially non-compressible, and cemented rock comprising a degree of cementation at which the rock is substantially non-compressible;
for rock comprising friable sand, defining a first model specifying a dependence of seismic velocity upon pressure;
for rock comprising partially cemented rock, defining a second model specifying a dependence of seismic velocity upon pressure and a weighting function accounting for a degree of cementation of the rock;
for rock comprising cemented rock defining a third model demonstrating an insensitivity of seismic velocity to pressure; and
for a given dry rock moduli and porosity, determining a degree of cementation, selecting the appropriate model, and using the selected model to predict the sensitivity of seismic velocity to pressure;
wherein the degree of cementation is determined by modelling upper and lower elastic bounds based on the porosity of the rock and then establishing the weighting function to account for the degree of cementation of the rock and wherein the upper (stiff) bound is determined using the Dvorkin-Nur contact cement model in combination with the Hashin-Shtrikman model to determine the relationship between the elastic moduli and porosity for consolidated sands.

38. The method according to claim 37 wherein the upper bound is obtained by matching the Hertz-Mindlin model or Walton smooth pressure sensitive model with the lower bound Hashin-Shtrikman model at a very high pressure such that the upper bound superimposes onto the Dvorkin-Nur contact cement model for the cemented rock.

39. The method according to claim 37 wherein the degree of cementation at which the rock is considered substantially non-compressible and is therefore considered cemented rock is at least 10%.

40. The method according to claim 37 wherein the weighting function is obtained using a two-step Hashin-Shtrikman modeling approach whereby a first interpolation is performed between uncemented and cemented end members at a high porosity, followed by a second interpolation between the high porosity and low porosity (mineral point) end members.

41. The method according to claim 37 wherein the elastic bounds are determined separately for bulk modulus and shear modulus data such that different weighting functions (W_{K} and W_{G}) are obtained in relation to the bulk modulus and the shear modulus data.

42. The method according to claim 37 comprising the step of using the predicted pressure sensitivity to interpret seismic velocity data and thereby predict the composition of a rock formation.

43. The method according to claim 37 wherein the first model for rock comprising friable sand comprises the Hertz-Mindlin model or the Walton Smooth contact theory model.

44. The method according to claim 37 wherein the second model for rock comprising partially cemented rock comprises a modified contact model that is pressure sensitive.

45. The method according to claim 44 wherein the second model comprises the Walton smooth pressure sensitive model or the Hertz-Mindlin model (defining a Hashin-Shtrikman soft bound) in combination with the Dvorkin-Nur contact cement model or the Constant Cement model (defining a Hashin-Shtrikman stiff bound).

46. The method according to claim 37 wherein the lower (soft) bound is determined using the Hertz-Mindlin model or the Walton Smooth model in combination with the Hashin-Shtrikman model to determine the relationship between the elastic moduli and porosity for unconsolidated sands at a given pressure.

47. The method according to claim 37 wherein the weighting function is linear and varies between 0 representing no cementation and 1 representing the degree of cementation at which the rock is substantially non-compressible and therefore all grain contacts are taken to be cemented.

48. The method according to claim 37 wherein the bulk modulus weighting function, W_{K}, is calculated from:
$${W}_{K} = \frac{{K}_{dry} ( {P}_{0} ) - {K}_{soft} ( {P}_{0} )}{{K}_{stiff} - {K}_{soft} ( {P}_{0} )}$$
where K_{dry} is the pressure sensitive dry bulk modulus (which has been modelled or observed) at porosity (P₀), K_{soft} is the pressure sensitive lower bound bulk modulus at the same porosity (P₀), and K_{stiff} is the pressure insensitive upper bound bulk modulus at this porosity value.

49. The method according to claim 37 wherein the shear modulus weighting function, W_{G}, is calculated from:
$${W}_{G} = \frac{{G}_{dry} ( {P}_{0} ) - {G}_{soft} ( {P}_{0} )}{{G}_{stiff} - {G}_{soft} ( {P}_{0} )}$$
where G_{dry} is the pressure sensitive dry shear modulus (which has been modelled or observed) at porosity (P₀), G_{soft} is the pressure sensitive lower bound bulk modulus at the same porosity (P₀), and G_{stiff} is the pressure insensitive upper bound bulk modulus at this porosity value.

50. The method according to claim 37 wherein the pressure dependence of the dry bulk and shear elastic moduli are obtained from:
K_{dry}(P_{eff})=(1−W_{K})·K_{soft}(P_{eff})+W_{K}·K_{stiff}
G_{dry}(P_{eff})=(1−W_{G})·G_{soft}(P_{eff})+W_{G}·G_{stiff}
where K_{dry} is the pressure sensitive dry bulk modulus at effective pressure (P_{eff}), W_{K} is the bulk modulus weighting function, K_{soft} is the pressure sensitive lower bound bulk modulus at effective pressure (P_{eff}), K_{stiff} is the pressure insensitive upper bound bulk modulus at effective pressure (P_{eff}), G_{dry} is the pressure sensitive dry shear modulus at effective pressure (P_{eff}), W_{G} is the shear modulus weighting function, G_{soft} is the pressure sensitive lower bound shear modulus at effective pressure (P_{eff}), and G_{stiff} is the pressure insensitive upper bound shear modulus at effective pressure (P_{eff}).

51. The method according to claim 50 comprising calculating the expected seismic velocities and acoustic impedances at various pressures, from the dry elastic moduli.

52. The method according to claim 51 comprising mapping well log data against the modelled data and correlating the results so as to establish the rock properties giving rise to the well log data.

53. The method according to claim 37 wherein regression modelling is employed on a simulated dataset so as to derive equations for calculating seismic velocities directly from porosity, effective pressure and cement volume values.

54. A computer system configured to carry out the method according to claim 37.

55. A computer program, comprising computer readable code which, when run on a computer system causes the computer system to carry out the method according to claim 37.

56. A computer program product comprising a computer readable medium and a computer program according to claim 55, wherein the computer program is stored on the computer readable medium.
